(19) United States
(12) Patent Application Publication
(10) Pub. No.: US 2020/0090465 A1
(43) Pub. Date: Mar. 19, 2020

(54) Process and system for electronic games where tickets are awarded that can be redeemed for real items

(71) Applicants: Ben Turner, Little Rock, AR (US); Brian Clearman, Midland, TX (US); Craig Vowell, Philadelphia, MS (US); Dan Graham, Philadelphia, MS (US); Matt Nabors, Frisch, TX (US); Chad McCaslin, Tyler, TX (US)

(72) Inventors: Ben Turner, Little Rock, AR (US); Brian Clearman, Midland, TX (US); Craig Vowell, Philadelphia, MS (US); Dan Graham, Philadelphia, MS (US); Matt Nabors, Frisch, TX (US); Chad McCaslin, Tyler, TX (US)

(21) Appl. No.: 15/821,602

(22) Filed: Nov. 22, 2017

(51) Int. Cl. G07F 17/32

(52) U.S. Cl. CPC G07F 17/3253; G07F 17/3248

(57) ABSTRACT

This current invention is a system and app that is a treasure chest full of games that a user can play to earn tickets electronically. These tickets can be used to be turned in for real goods and prizes. Players will use tokens to play the games. The system will have virtual toy chests displaying what can be purchased with the tickets.

### CROSS-REFERENCES TO RELATED APPLICATIONS (IF ANY)

None

### BACKGROUND

### 1. Field of the Invention

The present invention relates to electronic games and more particularly ones that award tickets that can be used to buy prizes.

### 2. Description of Prior Art

Currently, there are no applications on the market that allow the playing of family friendly games for tickets that can be used to purchase real life items.

There is still room for improvement in the art.

### SUMMARY OF THE INVENTION

This current invention is a system and application (app) that is a treasure chest full of games that a user can play to earn tickets electronically. These tickets can be used to be turned in for real goods and prizes.

The system, in the preferred embodiment, would work like a smartphone application, this product would be available through the respective marketplace for smartphones.

There would be two ways to play; Free Play & Members Area. With free play the players get an allotted tokens to play per time period like a day. With members area, the players can purchase tokens to play and it may have addition games. This way players can still play if they run out of their daily allotted tokens.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample of a home screen;

FIG. 4 displays the arcade games screen;

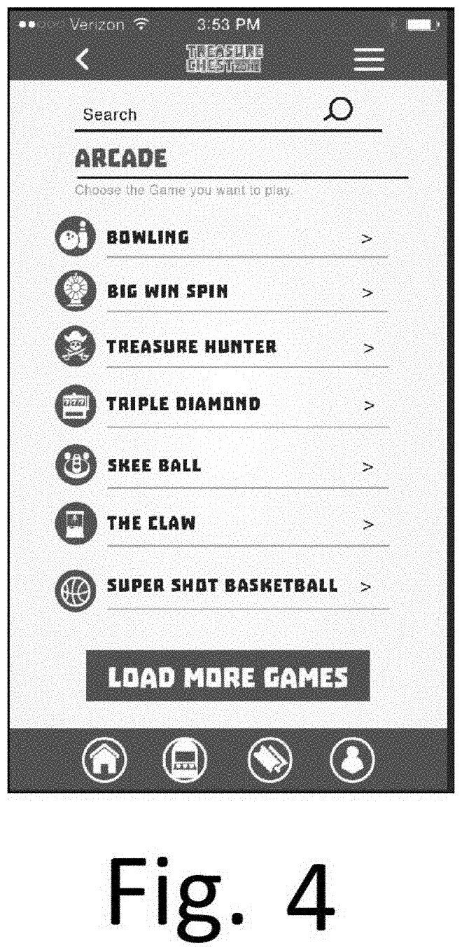

FIG. 5 displays a sample start game screen;

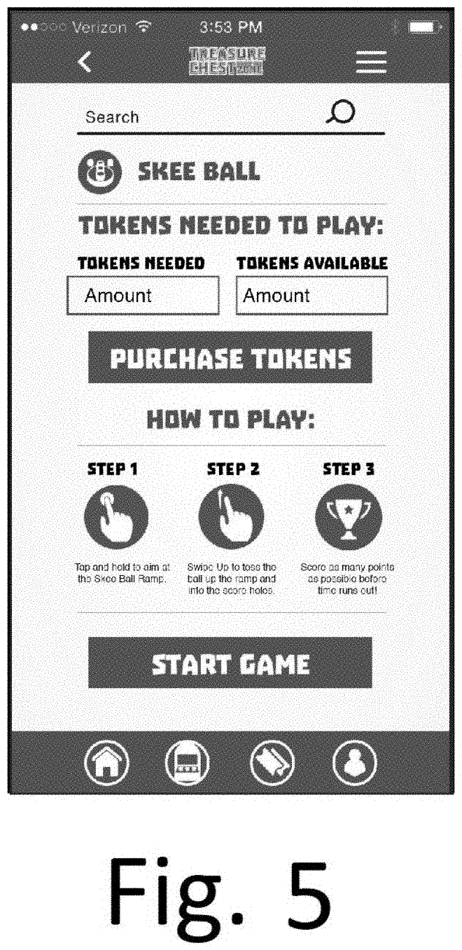

FIG. 6 shows a sample Skee-Ball screen;

FIG. 7 shows a sample bowling screen;

FIG. 8 shows a sample wheel game screen;

FIG. 9 shows a sample end of game screen;

FIG. 10 shows a sample redemption screen;

FIG. 11 shows a redemption screen with pictures;

FIG. 12 shows a sample purchase screen; and

FIG. 13 shows a sample profile screen.

### DESCRIPTION OF THE PREFERRED EMBODIMENT

There are a number of significant design features and improvements incorporated within the invention.

The current invention is a system 1 and application that would allow a user to play a number of different games electronically for tickets and redeem those tickets from real prizes.

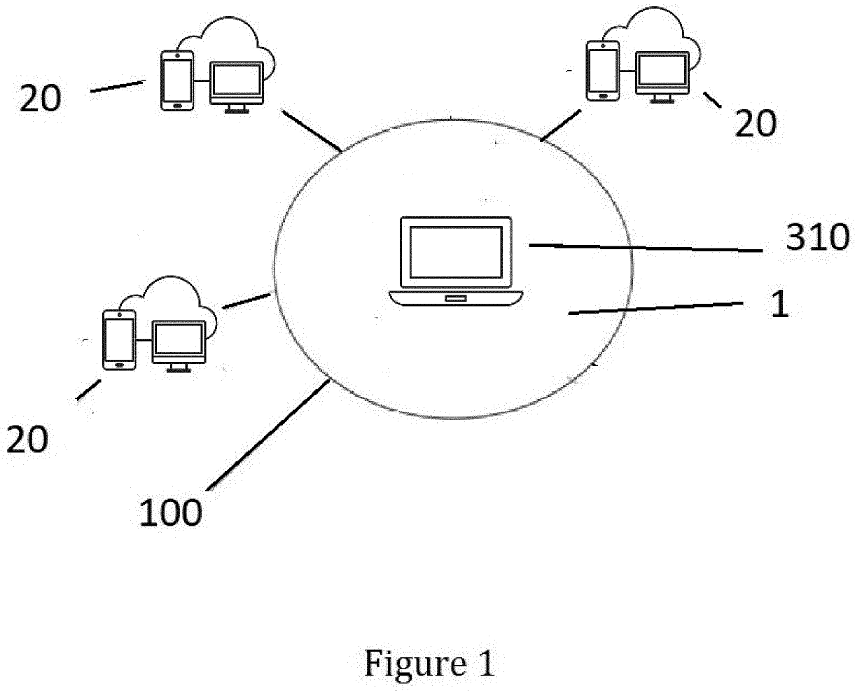

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

Brief Overview

This current invention is a system 1 and computer application that is used to provide electronic games for users. The user would use tokens to pay for these games and would be awarded tickets that could be used to buy real life prizes. The system 1 will include each user feature separate from the other or combined.

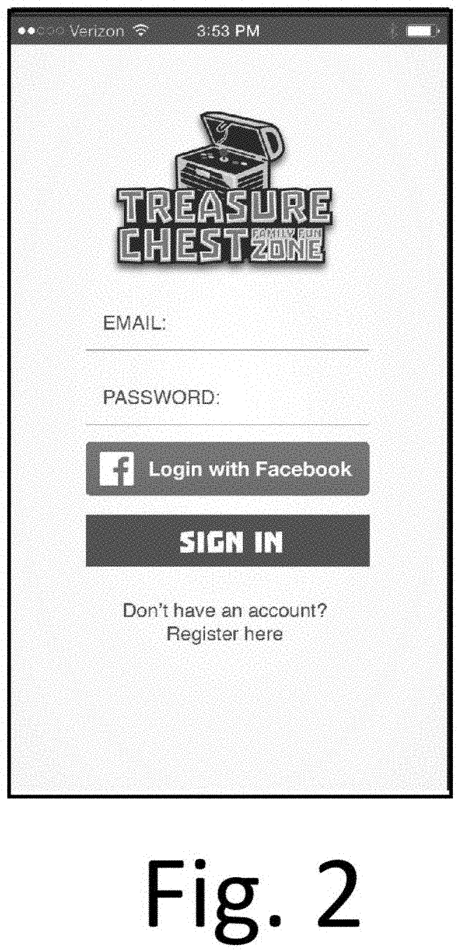

The users would sign-in directly or using social logins as shown in FIG. 2 with the user registering the app.

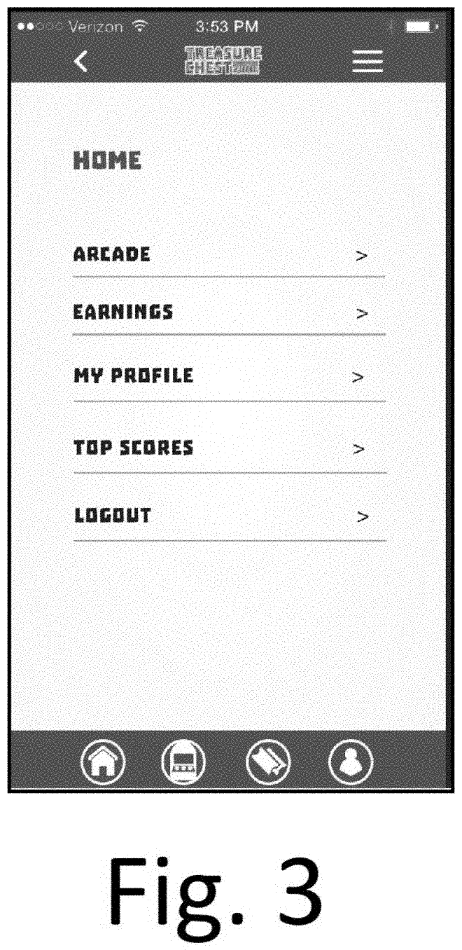

As shown in FIG. 3, the system 1 would have a number of games that a user can play. These games include such games as Ski Ball, Basketball, Ticket Wheel and Bouncy Ball Drop. The system 1 would also have treasure chest which is a game where the user will try to get treasures and other items out of the location that they are in without touching the sides of the of the hole or area that the treasure is in. If the sides are touched a buzzer will go off and the player will lose a turn. If the user correctly removes the treasure or item they are rewarded tickets.

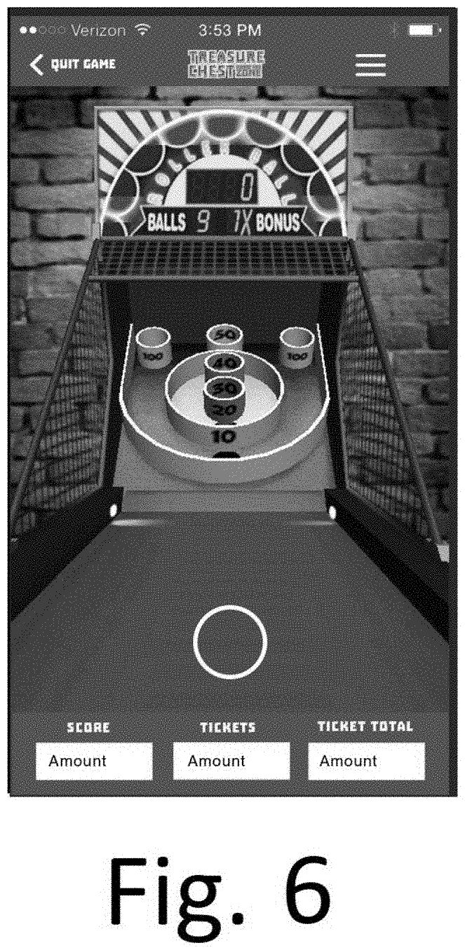

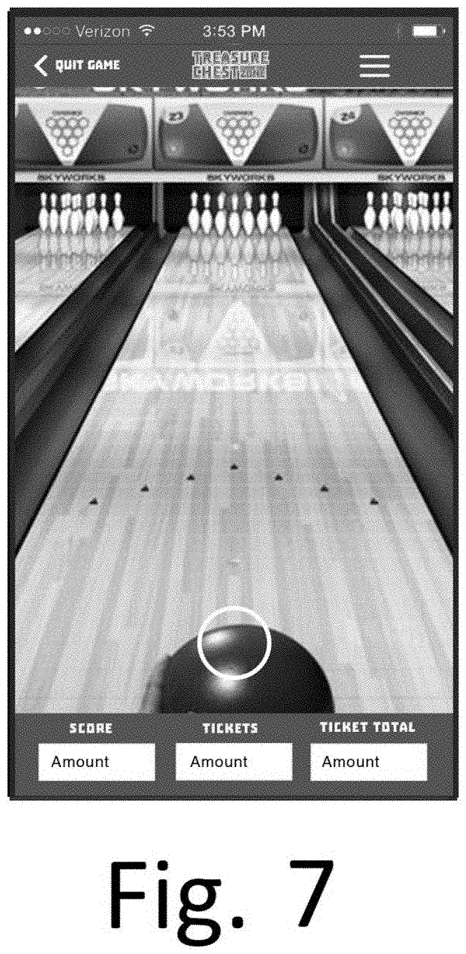

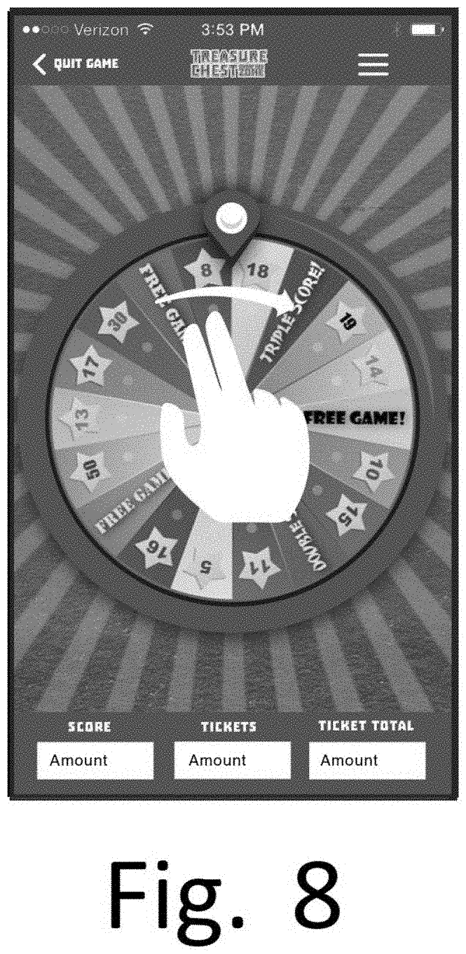

FIG. 6 shows a sample Skee-Ball screen for a Skee-Ball game. A sample bowling game is shown in FIG. 7. FIG. 8 shows a sample wheel game screen with a hand to turn the wheel.

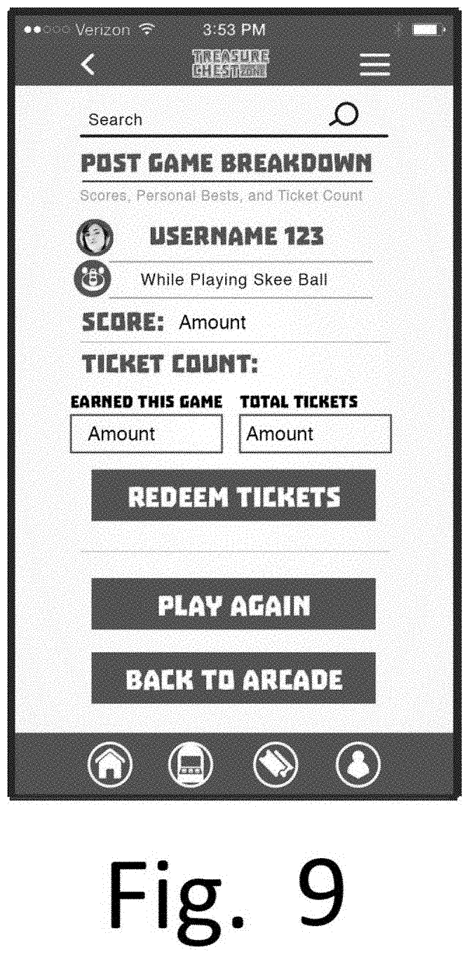

Users are player who buy tokens to play the games. As shown in FIG. 9, Players win tickets based on how well they play the games. These tickets can be used to trade in for real prizes found in a “Virtual Toy Chest.” In the preferred embodiment, the prizes would be carnival type prizes. For teens/adults which may include electronics, fan/team apparel, etc. to broaden market appeal.

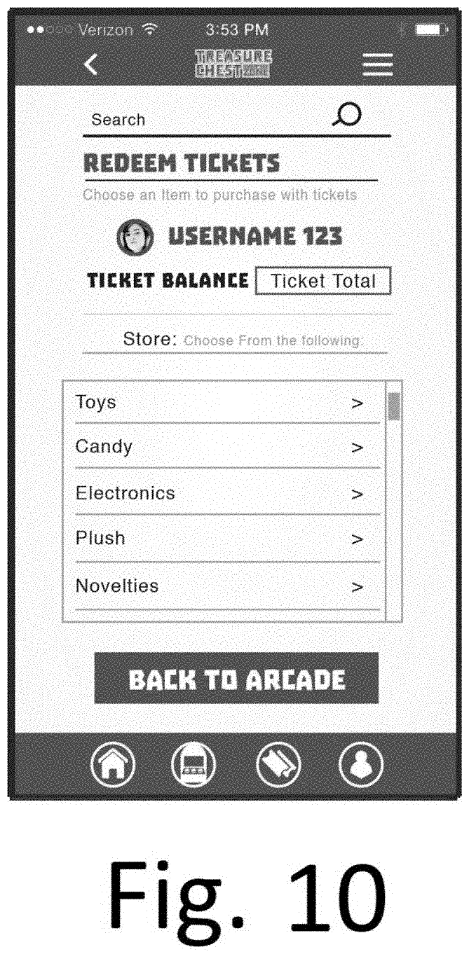

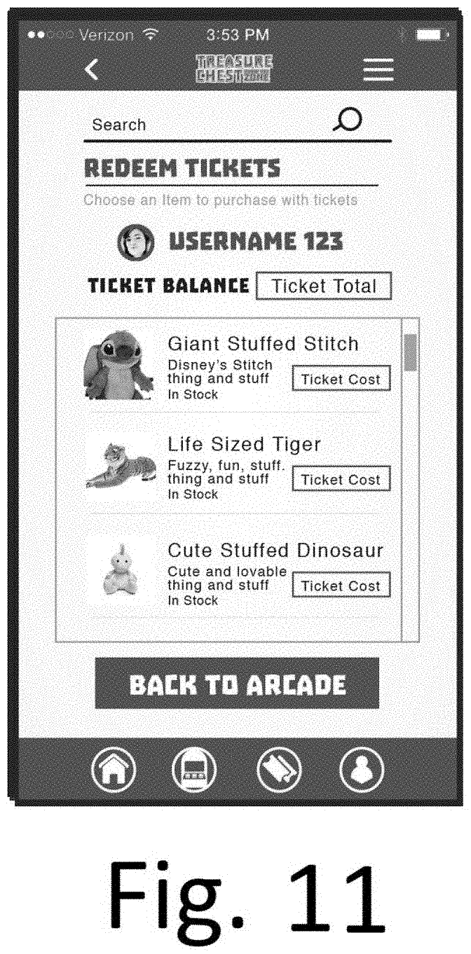

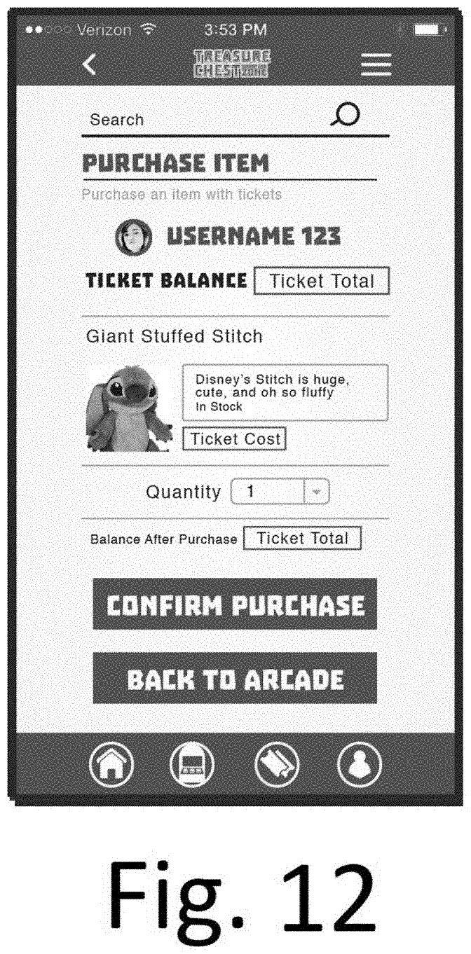

The ticket value and the minimum redeemable amount must correlate with amount of time spent on the system 1 to warrant shipping charges and products rendered (ex . . . player must reach 50,000 tickets before they can go shopping in the virtual toy chest). The tickets can be redeemed for prizes as shown in FIG. 10 while FIG. 11 shows a redemption screen with pictures of the prizes. FIG. 12 shows a sample purchase screen for the purchase of prizes. All prizes will be shipped through 3rd party vendors.

There would be two ways to play; Free Play & Members Area. With free play the players get an allotted tokens to play per time period like a day. With members area, the players can purchase tokens to play and it may have addition games. This way players can still play if they run out of their daily allotted tokens.

In the preferred embodiment, there would be two different virtual toy chests. The first Toy Chest would be the free play toy chest for free play members. This could include children without parents' permission to purchase a VIP membership. This free toy chest would only contain thing like carnival prizes.

The second would be the VIP Toy Chest. This toy chest would be for members and be filled with higher end items. Both Toy Chests will be viewable by all, which will encourage all to purchase a Membership.

In another embodiment, a user must buy a membership before they can redeem any prizes. The users/players will receive an allotted amount of tokens per day just for playing. Once those tokens run out, they may purchase more to continue in the member's section.

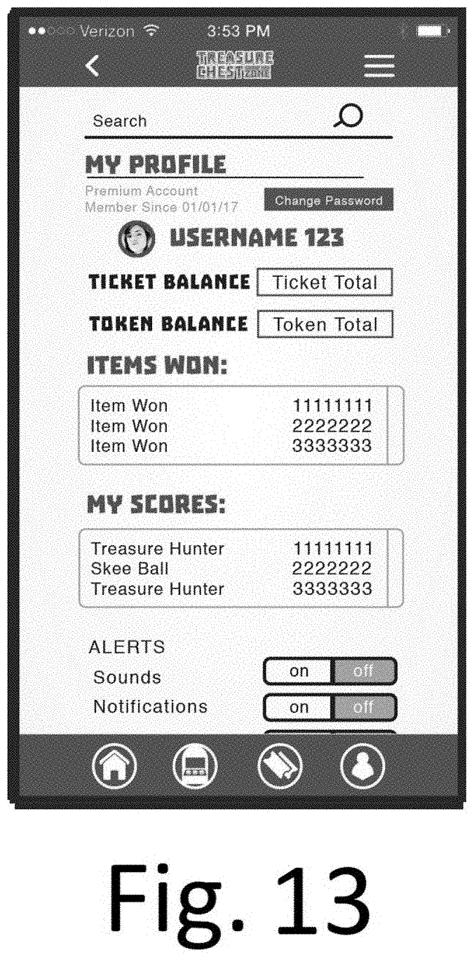

The user will set up their profile for the system using the profile screen as shown in FIG. 13 as well as the payment method. The profile screen will show the number of tickets earned and the information about the player such as name, game name and contact information.

Advantages

The current invention is a one-stop shop for family fun. It is a laugh-a-minute app for any computing device such as a smartphone or tablet and suitable for all the family. Users can create a profile for every adventurous gamer.

Conclusion

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system comprising;
having a system that resides in the non-transitory memory of a computing device;
displaying a plurality of games; using tokens to purchase the ability to play a one of the games, earning ticket based on how well the game is played and on the difficulty of the game, using tickets to buy real non-monetary prizes from a prize screen where the value of the prize is based on the number of ticket to purchase the prize and having one or more viewable virtual toy chests showing prizes that can be purchased with the tickets.

2. (canceled)

3. (canceled)

4. A system according to claim 1 having a profile screen.

5. (canceled)

6. (canceled)

7. A system according to claim 1 being free to play.

8. A system according to claim 1 being based on a paid membership.

9. A system according to claim 1 having both a free to play and paid membership.

10. A system according to claim 1 having one or more of the following set of games Ski Ball, Basketball, Ticket Wheel and Bouncy Ball Drop.

11. A system according to claim 1 having a treasure hunt game where the player attempts to remove an item out of the location without touch the sides of the area around the item.

12. (canceled)

13. (canceled)
